(19) United States
(12) Patent Application Publication
(10) Pub. No.: US 2006/0278738 A1
(43) Pub. Date: Dec. 14, 2006

(54) Fluid spray device that utilizes a check valve

(75) Inventor: Daniel E. Steerman, Harpers Ferry, WV (US)

Correspondence Address: LARRY J. GUFFEY, WORLD TRADE CENER - SUITE 1800, 401 EAST PRATT STREET, BALTIMORE, MD, 21202, US

(73) Assignee: Bowles Fluidics Corporation

(21) Appl. No.: 11/449,458

(22) Filed: Jun. 8, 2006

Related U.S. Application Data
(60) Provisional application No. 60/688,909, filed on Jun. 9, 2005.

(51) Int. Cl. B05B 1/30

(52) U.S. Cl. 239/570; 239/589.1; 239/587.4

(57) ABSTRACT

An improved fluid spray assembly of the type having a primary housing, which has an exterior surface with front and rear faces and an opening in the front face that exposes a cavity in the housing, and a check valve, which has an exterior surface with upstream and downstream faces, further includes (a) a secondary housing which has an exterior surface with front and rear faces and a fluid flow passage that extends between the secondary housing's faces, and wherein: (b) the primary housing's cavity has a boundary surface which includes a rear portion with a port and a intermediate portion that extends between said cavity opening and said rear portion, (c) the housing exterior surface rear face has an inlet which is connected to the cavity's port by a connecting flow passage, and (d) the primary housing cavity's intermediate boundary surface is configured so as to accommodate the placement through the primary housing opening and the holding in place of both the check valve and the secondary housing.

### CROSS-REFERENCE TO RELATED APPLICATION

This application claims the benefit of Provisional Patent Application No. 60/688,909, filed Jun. 9, 2005 by Dan Steerman. The teachings of this application are incorporated herein by reference to the extent that they do not conflict with the teaching herein.

### BACKGROUND OF THE INVENTION

1. Field of the Invention

This invention relates to fluid handling apparatus. More particularly, this invention relates to an improvement for design of the housings for fluid spray devices of the type that utilize check valves.

2. Description of the Related Art

Windshield washer spray systems or assemblies that utilize fluidic oscillators or inserts are well known in the art. Generally, they consist of windshield washer nozzles that are mounted in the hood of a vehicle. The fluidic inserts in these nozzles cause a jet of windshield washer fluid to be oscillated laterally so as to project a fan spray of windshield washer droplets that impinge over the whole lateral width of a windshield.

Check valves are typically included in the washer fluid feed lines of these nozzles to eliminate “drool” due to: (a) dynamic loads on the windshield washer system when the car is moving, and (b) static loads on the hood-mounted system when the car is stationary, but its hood is lifted, and to shorten the response time of a windshield washer system.

For such windshield washer applications, the washer nozzle assembly typically includes two components: (1) a basic or primary housing that contains a fluid flow passage having an interior portion that is configured as a cavity into which a fluidic oscillator is insert through the passage's outlet, and (2) an elbow or hose nipple which is joined to the housing passage's inlet and in which the check valve components are located. These two components are then welded together to prevent any leakage at their junction. See U.S. Pat. No. 5,636,794.

FIG. 1 from U.S. Pat. No. 6,948,513 shows an exploded view of a fluidic windshield washer assembly that employs such a two component washer nozzle. This assembly is seen to include: a fluidic oscillator or insert 2, a basic or primary housing 4, an elbow 6 and a state-of-the-art check valve 8 that includes a piston 10 and a spring 12. This piston has a resilient seal or rib on its bottom or upstream surface 14 that is configured to seal around the fluid outlet 16 of the elbow's top surface 18.

FIG. 2 shows an exploded view of an alternative version of a fluidic windshield washer assembly that also employs a two component, washer nozzle assembly. However, this version also uses a secondary housing 20 which has a flow passage which extends between its from and rear faces and which is configured so as to spray fluid from the secondary housing's front face. A portion of the exterior surface of the secondary housing is spherically-shaped and fits within a cavity in the primary housing that is similarly shaped so as to receive the secondary housing and allow it to be rotated such that the direction of spray from the oscillator can be adjusted over a range of settings. Thus, the secondary and primary housing effectively serve to create a ball and socket joint in which the ball is modified to have a flow nozzle place within it so as to allow fluid to flow from the ball.

Despite the relative maturity of this technology, such washer spray systems still have areas in which they can be improved. For example, because of the relatively complex nature of the shape of such nozzle's housing components, their fabrication costs are significant. Additionally, despite great attention to fully welding these components together, there continue to be instances in which the welds are inadequate or defect and leakage problems are reported.

Thus, despite the prior art, there still exists a continuing need for improvements in the design of those fluid spray devices that utilize check valves.

Objects and Advantage

Recognizing the need for the development of improved fluid spray devices, the present invention is generally directed to satisfying the needs set forth above and overcoming the disadvantages identified with prior art devices.

It is an object of the present invention to provide an improved fluid spray device for a windshield washer system that is easier to manufacture than those previously and currently used.

It is another object of the present invention to provide an improved fluid spray device for a windshield washer system that requires less manual labor to assemble.

It is yet another object of the present invention to provide a fluid spray device for a windshield washer system that has fewer components, thereby reducing the task of welding them together and further minimizing the chances of leaks from such hardware.

Other objects and advantages of the present invention will become readily apparent as the invention is better understood by reference to the accompanying drawings and the detailed description that follows.

### SUMMARY OF THE INVENTION

Recognizing the need for the development of improved liquid spray devices that utilize check valves, the present invention is generally directed to satisfying the needs set forth above and overcoming the disadvantages identified with prior art devices and methods.

In accordance with the present invention, an improved fluid spray assembly that operates on pressurized liquid flowing through it to generate a jet of liquid that flows into a surrounding gaseous environment and forms a spray of liquid droplets (in which the spray is characterized, in part, by its horizontal and vertical angles of spread) includes in a first preferred embodiment: (a) a primary housing having an exterior surface with front and rear faces and an opening in the front face that exposes a cavity in the housing, (b) a check valve having an exterior surface with upstream and downstream faces, and (c) a secondary housing which has an exterior surface with front and rear faces and a fluid flow passage that extends between the secondary housing's faces, and wherein: (d) the primary housing's cavity has a boundary surface which includes a rear portion with a port and a intermediate portion that extends between said cavity opening and said rear portion, (e) the housing exterior surface rear face has an inlet which is connected to the cavity's port by a connecting flow passage, and (f) the primary housing cavity's intermediate boundary surface is configured so as to accommodate the placement through the primary housing opening and the holding in place of both the check valve and the secondary housing.

In a second preferred embodiment, this improved fluid spray device further includes a fluidic insert having an exterior surface with an upstream face and a downstream face, and wherein a portion of the secondary housing flow passage that is proximate this housing's rear face is configured to allow for the insertion of this fluidic insert into the secondary housing's flow passage.

In a third preferred embodiment, this improved fluid spray device is further adapted such that its check valve includes a piston having a front and a rear end and a spring having a front and a rear end, and wherein the check valve's upstream face, as described above, is equivalent to this piston's rear end and the check valve's downstream face, as described above, is equivalent to this spring's front end.

Thus, there has been summarized above, rather broadly and understanding that there are other preferred embodiments which have not been summarized above, the present invention in order that the detailed description that follows may be better understood and appreciated. There are, of course, additional features of the invention that will be described hereinafter and which will form the subject matter of the claims to this invention.

### BRIEF DESCRIPTION OF THE DRAWINGS

FIG. 1 shows an exploded view of a prior art fluidic windshield washer assembly that employs a two component (i.e., primary housing and elbow) washer nozzle.

FIG. 2 shows an exploded view of an alternative version of a prior art fluidic windshield washer assembly that also employs the standard two component washer nozzle, while also introducing a secondary housing which is adjustable so as to allow the direction of this assembly's spray to be aimed.

FIGS. 3A-3D show respective exploded perspective, assembled cross-sectional, assembled perspective and exploded cross-sectional views of a first preferred embodiment of the present invention that yields an adjustable oscillating spray.

FIGS. 4A-4D show respective exploded perspective, assembled cross-sectional, assembled perspective and exploded cross-sectional views of a second preferred embodiment of the present invention that yields a non-adjustable oscillating spray.

FIGS. 5A-5D show respective exploded perspective, assembled cross-sectional, assembled perspective and exploded cross-sectional views of a third preferred embodiment of the present invention that yields an adjustable shear spray.

FIGS. 6A-6D show respective exploded perspective, assembled cross-sectional, assembled perspective and exploded cross-sectional views of a fourth preferred embodiment of the present invention that yields an adjustable spray in the form of a round jet.

FIGS. 7A-7D show alternative versions of check valves that are suitable for use with various embodiments of the present invention.

FIGS. 8A-8B show a perspective and an exploded cross-sectional view of an automotive panel into which a primary housing of the present invention has been molded.

### DESCRIPTION OF THE PREFERRED EMBODIMENTS

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

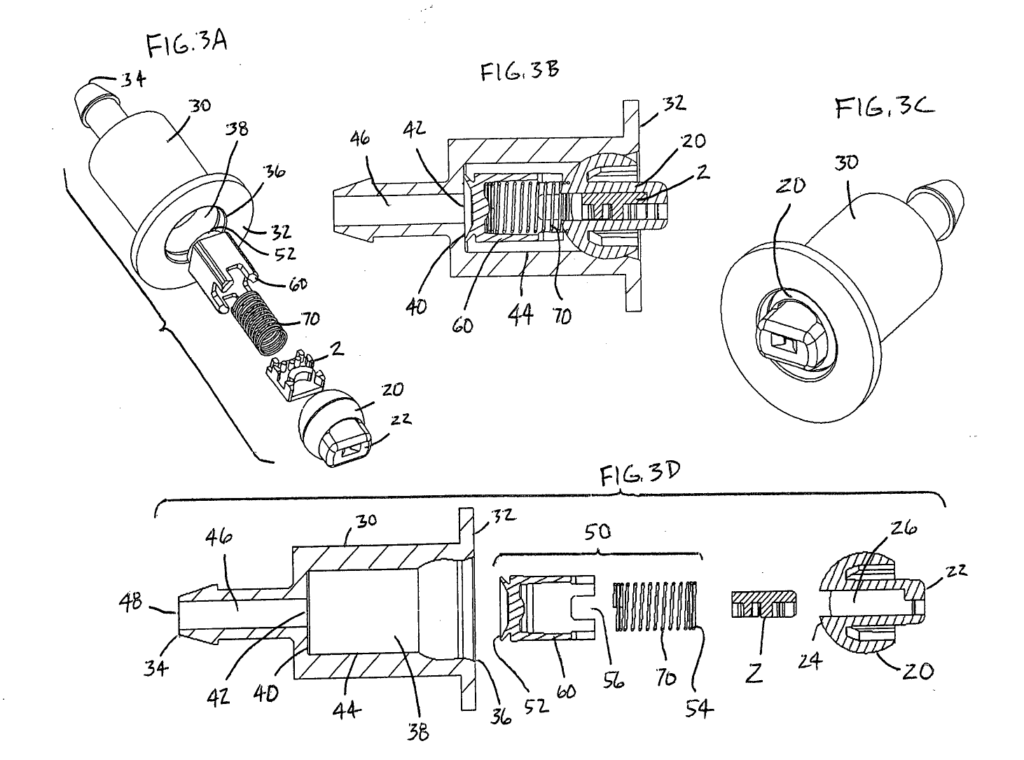

A first preferred embodiment of the present invention is shown in FIGS. 3A-3D which show respective exploded perspective, assembled cross-sectional, assembled perspective and exploded cross-sectional views. Its various parts include a secondary housing 20 which has front 22 and rear 24 faces and a flow passage 26 that extends between these faces.

In this first embodiment, the upstream portion of this flow passage at the housing's rear face 24 is configured to accommodate a fluidic oscillator or insert 2 that is inserted into the secondary housing from its rear face 24. The advantage of this arrangement is that this assembly can be provided with any one of a variety of oscillating spray patterns by molding into the insert any one of a number of well known fluidic circuits. Alternatively, the secondary housing can be made to split on its centerline into two halves and a specific fluidic circuit or other type of spray circuit (e.g., non-oscillation shear or round jets) can be molded into the faces which result from this splitting the secondary housing—such a split secondary housing can thus only issue a single type of spray.

The exterior surface of this secondary housing is seen to have a spherical portion. As will be seen below, this allows for the direction of the spray that issues from this housing's front face to be adjusted so that it can be directed over any one of a wide range of directions relative to the assembly's centerline.

This embodiment also includes a new type of primary housing 30 into which the secondary housing 20 is press fitted. This primary housing has an exterior surface with front 32 and rear 34 faces and an opening 36 in the front face that exposes a cavity 38 that extends into the primary housing's interior. This cavity has a boundary surface that includes a rear portion 40 with a port 42 and an intermediate portion 44 that extends between the cavity's opening and its rear portion. A primary housing flow passage 46 connects this port 42 and an inlet 48 that is situated in primary housing's rear face 34.

This embodiment also includes a check valve 50 that has an exterior surface that includes upstream 52 and downstream 54 faces, and a flow passage 56 that allows for fluid to flow through and between the check valve's faces. There are many versions of check valves that are compatible with the present embodiment. See FIGS. 7A-7D. Shown in FIGS. 3A-3D is a check valve 50 that includes a piston 60 and a spring 70.

To allow these elements to fit properly together in this first embodiment, it is necessary that the primary housing cavity's intermediate boundary surface 44 be configured so as to accommodate the placement through its front face opening of both the check valve 50 and the secondary housing 20, including that portion of its exterior surface which is spherical in shape. The boundary's surface's is also configured such as to hold these elements in place and properly aligned with the check valve's upstream face 52 resting on a portion of the cavity's rear portion 44 and its downstream face resting on a portion of the secondary housing's rear face 24. The spherical nature of a portion of the secondary housing's exterior surface results in a portion of the cavity's boundary surface effectively forming a socket so that the secondary housing has ball-and-socket adjustability in its primary housing 30.

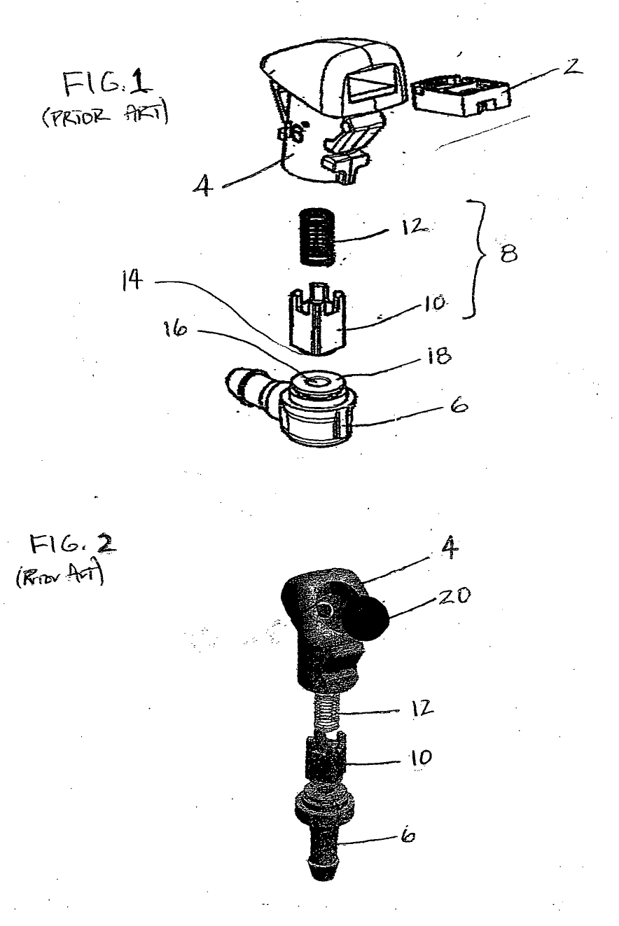

An advantage of this first embodiment is clearly seen to be the elimination of the prior art's elbow or nipple component 6, see FIGS. 1 and 2, that had to be welded to a boundary surface near the primary housing's inlet in prior art designs of such spray assemblies. This component can be eliminated because the present invention's primary housing's cavity 38 has been configured so that, in this instance, the piston 60 and the spring 70 which it holds can be accommodated within this cavity and behind the rear surface 24 of the secondary housing 20.

The exterior surface of this primary housing 30 will usually be configured so as to aid in the mounting of this sprayer assembly. For example, FIG. 3 shows an assembly that is designed to be mounted horizontally beneath a hood in an automotive windshield sprayer application. Thus, this version of a primary housing has been molded with an input nipple that allows for a hose connection to be made to the housing's inlet 48.

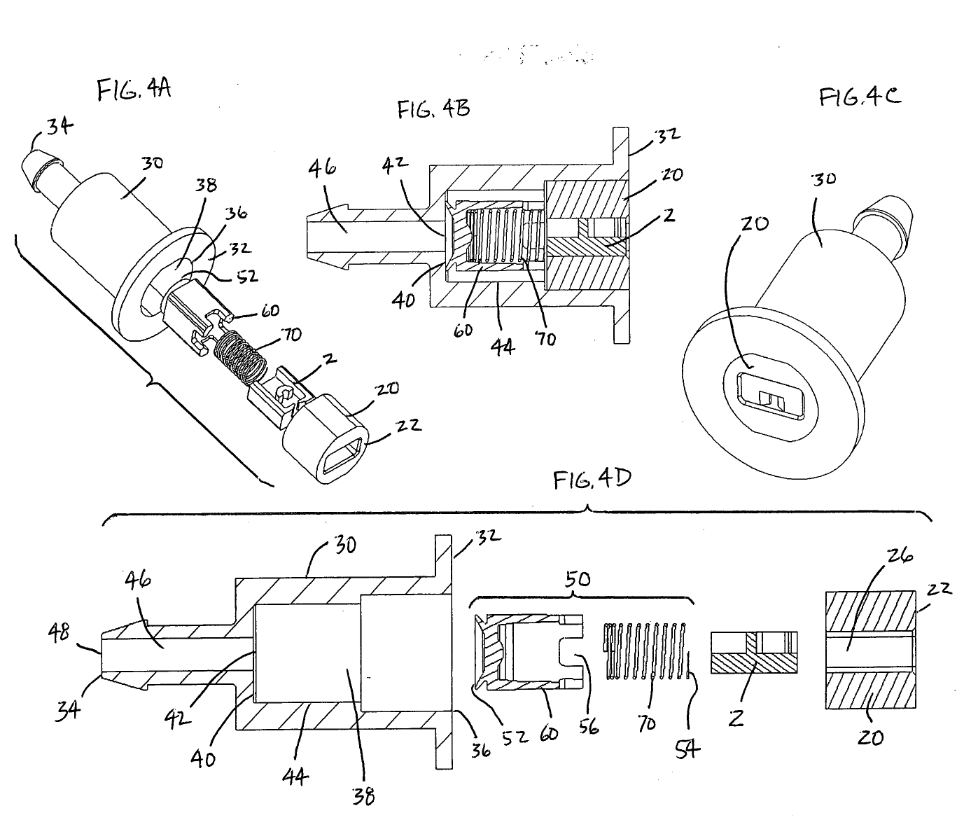

Shown in FIGS. 4A-4D is a second preferred embodiment of the present invention. It differs from that shown in FIG. 3 by the design of the exterior surface of its secondary housing 30. In this embodiment, it is no longer desirable to have the direction of the spray from this assembly be adjustable. Thus, there is no portion of the secondary housing's exterior surface which is spherical in shape. This housing's cross-sectional shape is shown here as being somewhat rectangular with rounded corners. However, it could just have easily have been square or purely rectangular, etc.

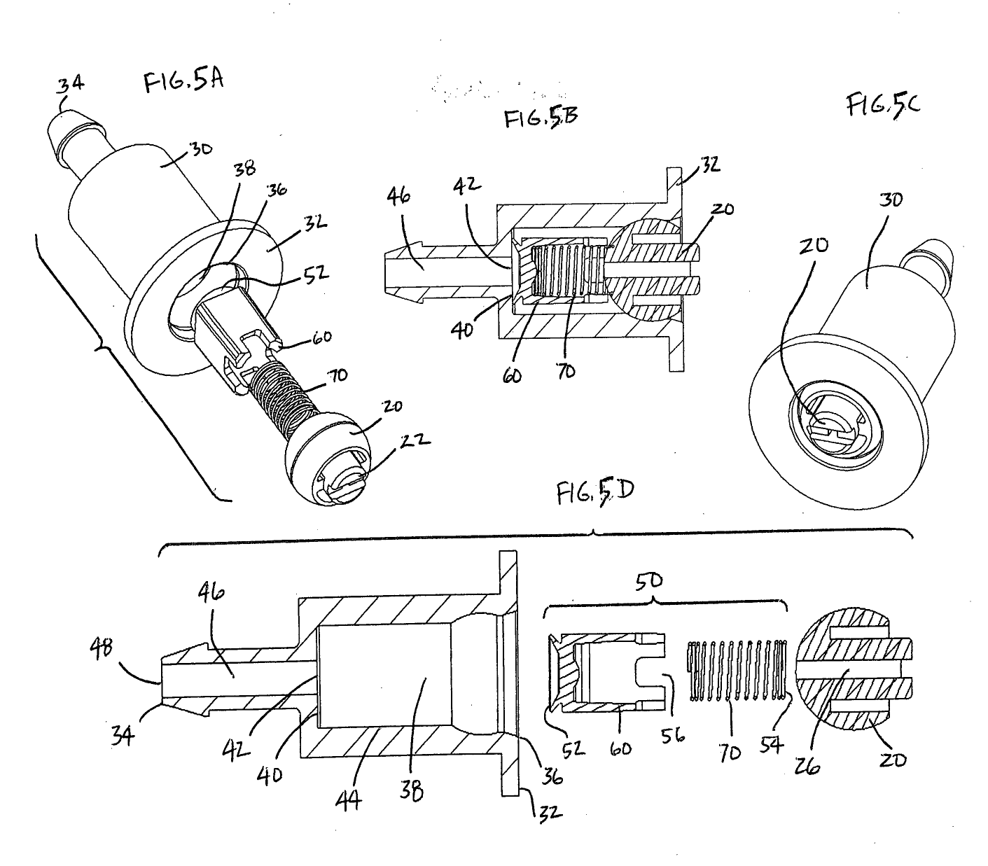

Shown in FIGS. 5A-5D is a third preferred embodiment of the present invention. It differs from that shown in FIG. 3 by the design of its secondary housing 30. In this embodiment, this housing is not designed to accept a fluidic oscillator or insert to be inserted into its rear face 24. This assembly is not designed to provide an oscillating spray; it is designed to yield a shear spray. The secondary housing's flow passage 26 has molded into it the appropriate geometry to yield a shear spray that issues from its front face 22.

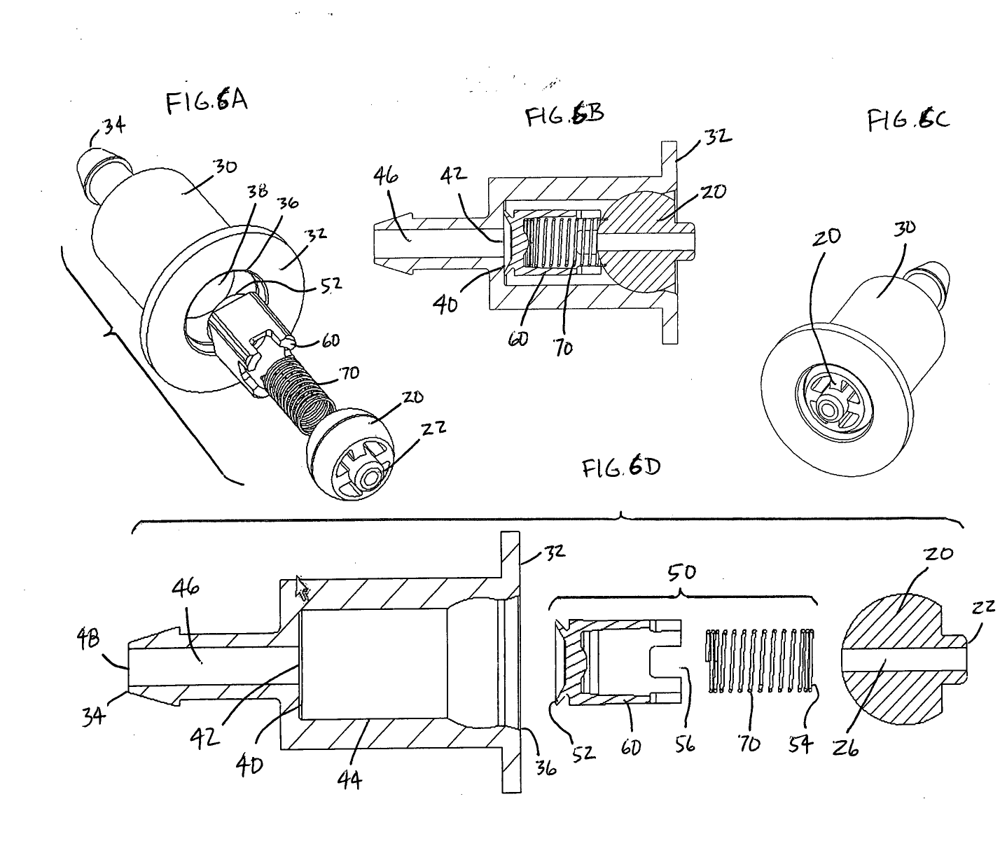

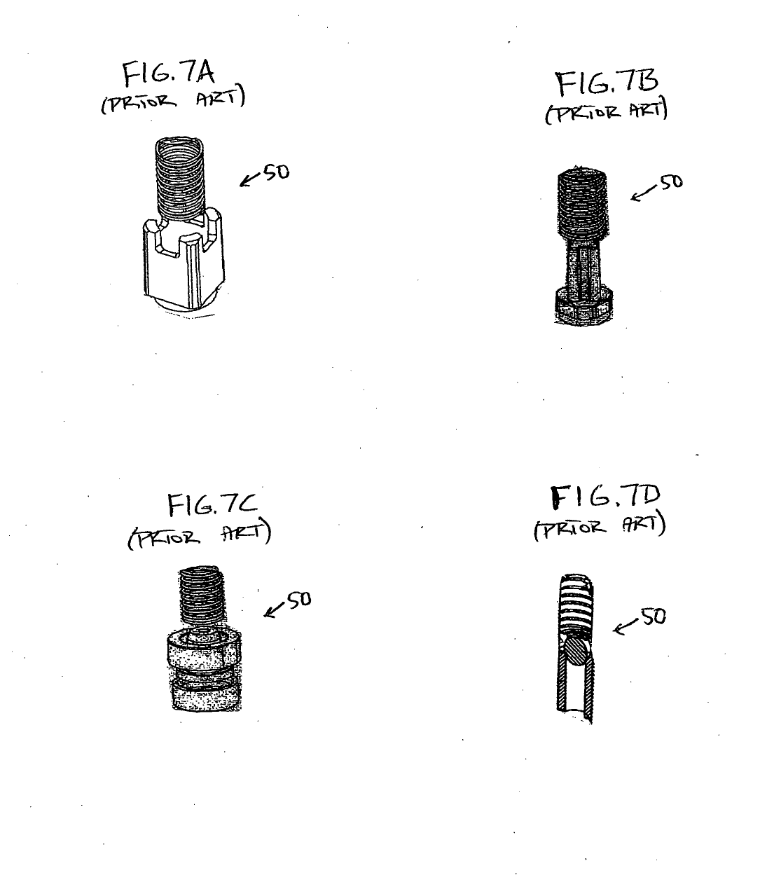

Shown in FIGS. 6A-6D is a fourth preferred embodiment of the present invention. It again differs from that shown in FIG. 3 by the design of its secondary housing 30. Similarly to the embodiment shown in FIG. 5, the secondary housing of this assembly is not designed to accept a fluidic oscillator or insert for insertion into its rear face 24. This assembly is not designed to provide an oscillating spray; it is designed to yield a spray in the form of a round jet. The secondary housing's flow passage 26 has molded into it the appropriate geometry to yield a round jet of spray that issues from its front face 22.

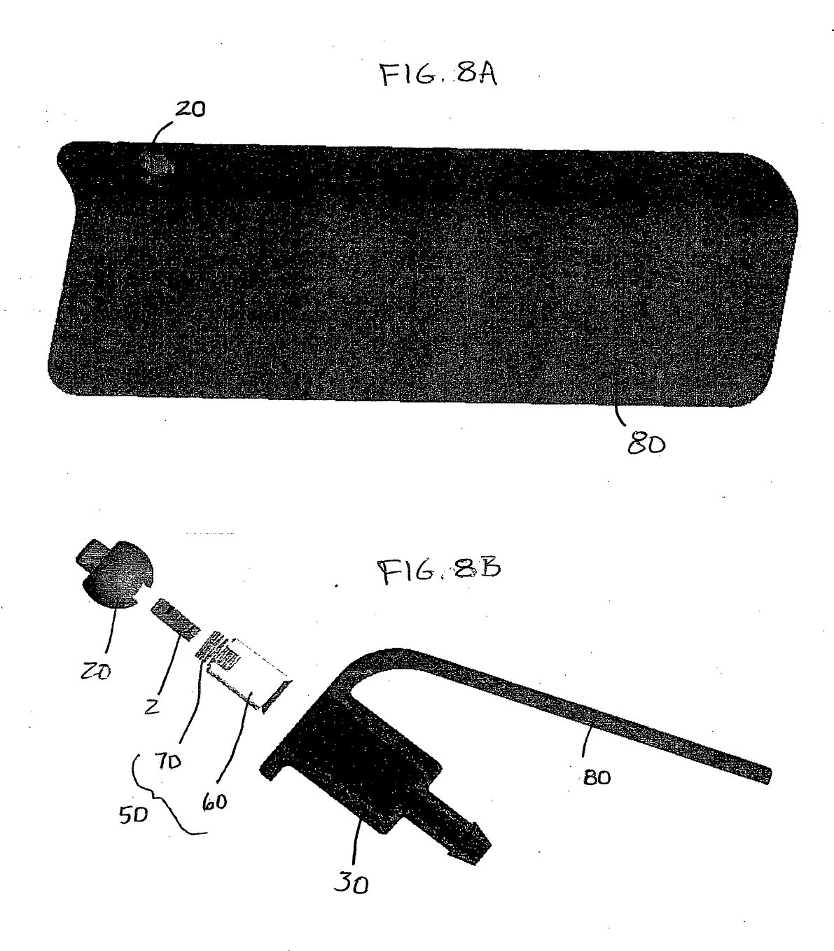

In yet another embodiment of the present invention that is applicable to automotive applications, the primary housing 30 of the present invention has been molded right into a panel 80 that makes up some portion of the exterior of the auto. See FIGS. 8A-8B which show a perspective and an exploded cross-sectional view of an automotive panel 80 into which the primary housing 30 has been molded.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention that is hereinafter set forth in the claims to this invention.

I claim:

1. A fluid spray assembly comprising:
a primary housing having an exterior surface with front and rear faces and an opening in said front face that exposes a cavity in said housing,
said cavity having a boundary surface that extends into said housing,
said cavity boundary surface including a rear portion and a intermediate portion that extends between said cavity opening and said rear portion,
said cavity boundary surface rear portion having a port,
said housing exterior surface rear face having an inlet,
said housing further having a flow passage that connects said inlet and said port,
a secondary housing having an exterior surface with front and rear faces and a fluid flow passage that extends between said secondary housing faces,
a check valve having an exterior surface that includes upstream and downstream faces,
wherein said primary housing cavity intermediate boundary surface configured so as to accommodate the placement through said primary housing opening of said check valve into said cavity so that the upstream face of said valve is proximate said cavity rear portion, and
wherein said primary housing cavity intermediate boundary surface further configured so as to accommodate the placement through said primary housing opening and the holding of said secondary housing in said cavity so that the downstream face of said check valve is proximate said secondary housing rear face.

2. The fluid spray assembly as recited in claim 1, further comprising:
a fluidic insert having an exterior surface with an upstream face and a downstream face, and
wherein a portion of said secondary housing flow passage that is proximate said secondary housing rear face being configured to allow for the insertion of said fluidic insert into said secondary housing flow passage.

3. The fluid spray assembly as recited in claim 1, wherein:
a portion of said secondary housing flow passage being configured to provide a spray pattern from said assembly that is chosen from the group of spray patterns denoted herein as shear, oscillating or round jet.

4. The fluid spray assembly as recited in claim 1, wherein:
said check valve including a piston having a front and a rear end and a spring having a front and a rear end, and
wherein said check valve upstream face is said piston rear end and said check valve downstream face is said spring front end.

5. The fluid spray assembly as recited in claim 2, wherein:
said check valve including a piston having a front and a rear end and a spring having a front and a rear end, and
wherein said check valve upstream face is said piston rear end and said check valve downstream dace is said spring front end.

6. The fluid spray assembly as recited in claim 3, wherein:
said check valve including a piston having a front and a rear end and a spring having a front and a rear end, and
wherein said check valve upstream face is said piston rear end and said check valve downstream face is said spring front end.

7. The fluid spray assembly as recited in claim 1, wherein:
said secondary housing exterior surface having a portion that is spherical shaped so as to provide adjustability for the orientation of said spray from said assembly.

8. The fluid spray assembly as recited in claim 2, wherein:
said secondary housing exterior surface having a portion that is spherical shaped so as to provide adjustability for the orientation of said spray from said assembly.

9. The fluid spray assembly as recited in claim 3, wherein:
said secondary housing exterior surface having a portion that is spherical shaped so as to provide adjustability for the orientation of said spray from said assembly.

10. The fluid spray assembly as recited in claim 4, wherein:
said secondary housing exterior surface having a portion that is spherical shaped so as to provide adjustability for the orientation of said spray from said assembly.

11. A method for fabricating a fluid spray assembly, said method comprising the steps of:
fabricating a primary housing having an exterior surface with front and rear faces and an opening in said front face that exposes a cavity in said housing,
said cavity having a boundary surface that extends into said housing,
said cavity boundary surface including a rear portion and a intermediate portion that extends between said cavity opening and said rear portion,
said cavity boundary surface rear portion having a port,
said housing exterior surface rear face having an inlet,
said housing further having a flow passage that connects said inlet and said port,
fabricating a secondary housing having an exterior surface with front and rear faces and a fluid flow passage that extends between said secondary housing faces,
fabricating a check valve having an exterior surface that includes upstream and downstream faces,
wherein said primary housing cavity intermediate boundary surface configured so as to accommodate the placement through said primary housing opening of said check valve into said cavity so that the upstream face of said valve is proximate said cavity rear portion, and
wherein said primary housing cavity intermediate boundary surface further configured so as to accommodate the placement through said primary housing opening and the holding of said secondary housing in said cavity so that the downstream face of said check valve is proximate said secondary housing rear face.

12. The method for fabricating a fluid spray assembly as recited in claim 10, further comprising the step of:
fabricating a fluidic insert having an exterior surface with an upstream face and a downstream face, and
wherein a portion of said secondary housing flow passage that is proximate said secondary housing rear face being configured to allow for the insertion of said fluidic insert into said secondary housing flow passage.

13. The method for fabricating a fluid spray assembly as recited in claim 10, wherein:
a portion of said secondary housing flow passage being configured to provide a spray pattern from said assembly that is chosen from the group of spray patterns denoted herein as shear, oscillating or round jet.

14. The method for fabricating a fluid spray assembly as recited in claim 10, wherein:
said check valve including a piston having a front and a rear end and a spring having a front and a rear end, and
wherein said check valve upstream face is said piston rear end and said check valve downstream face is said spring front end.

15. The method for fabricating a fluid spray assembly as recited in claim 12, wherein:
said check valve including a piston having a front and a rear end and a spring having a front and a rear end, and
wherein said check valve upstream face is said piston rear end and said check valve downstream dace is said spring front end.

16. The method for fabricating a fluid spray assembly as recited in claim 13, wherein:
said check valve including a piston having a front and a rear end and a spring having a front and a rear end, and
wherein said check valve upstream face is said piston rear end and said check valve downstream face is said spring front end.

17. The method for fabricating a fluid spray assembly as recited in claim 10, wherein:
said secondary housing exterior surface having a portion that is spherical shaped so as to provide adjustability for the orientation of said spray from said assembly.

18. The method for fabricating a fluid spray assembly as recited in claim 12, wherein:
said secondary housing exterior surface having a portion that is spherical shaped so as to provide adjustability for the orientation of said spray from said assembly.

19. The method for fabricating a fluid spray assembly as recited in claim 13, wherein:
said secondary housing exterior surface having a portion that is spherical shaped so as to provide adjustability for the orientation of said spray from said assembly.

20. The method for fabricating a fluid spray assembly as recited in claim 14, wherein:
said secondary housing exterior surface having a portion that is spherical shaped so as to provide adjustability for the orientation of said spray from said assembly.
